(19) United States
(12) Patent Application Publication
(10) Pub. No.: US 2009/0259152 A1
(43) Pub. Date: Oct. 15, 2009

(54) Device and Method for Alleviating Back Pain

(76) Inventor: Albert Nguyen, Santa Ana, CA (US)

Correspondence Address: G. L. LOOMIS & ASSOCIATES, INC., 990 HIGHLAND DRIVE, SUITE 212Q, SOLANA BEACH, CA, 92075, US

(21) Appl. No.: 12/101,822

(22) Filed: Apr. 11, 2008

(51) Int. Cl. A61H 7/00; A47C 16/00

(52) U.S. Cl. 601/84; 5/630

(57) ABSTRACT

The invention presents self-applied massaging devices useful for alleviating back pain. Such massage devices are readily portable and that can be employed by a user in either a supine or sitting position. A massaging device for alleviating back pain comprising a plurality of individual spherical elements, a flat base and a pliable covering that encasing the spherical elements and at least a portion of the flat base. The plurality of spherical elements are disposed upon the flat base such they are coplanar and are in intimate contact with the surface of the flat base so as to permit the spherical elements free rotational and translational movement while maintaining coplanarity.

### FIELD OF THE INVENTION

The invention relates to a device useful for alleviating back pain. More specifically the invention relates to a massage device that is readily portable and that can be employed by a user in either a supine or sitting position.

### BACKGROUND

Spinal and lower back muscular pain is a serious problem in many individuals worldwide. It is estimated that eight out of ten Americans will suffer from severe back pain during their lifetime. This type of pain, particularly among older or overweight individuals, can easily be aggravated during any type of body trauma such as heavy lifting or strenuous physical activity. Prescription drugs, which are not always effective, must often be used to alleviate lower back pain. Day-to-day activity requires movement of the back, which can lead to further muscular aggravation that requires use of the most potent pain relief medications to produce any positive result.

To help alleviate lower back pain, prevent injury or aid in recovery, a device that can provide support to the lower back to prevent muscular strain must be used. In the past, many types of devices have been created to help with this problem. Therefore, the art is replete with inventions which address the need to alleviate back pain, including support members having specific features and contours intended to support the vertebrae in a prone or supine position, in an effort to realign the spine along its original spinal curve (including the lumbar, thoracic and cervical curves). These devices range from wrap-type supports to individual solid support fixtures placed longitudinally along the back to restrain movement.

For example, U.S. Pat. No. 3,359,577 to Rogers describes a one-piece, back support device for engaging the back of a user, the support device having an arched profile (convex/concave in transverse planes) including a shoulder supporting portion and a lumbar region supporting portion. A cradling effect of the shoulder portion and the concave surface assists the user in finding a proper resting position, whereas the transverse convex surface aligns the spine, once the proper resting position has been found. The device provides a skeletal, vertically ribbed construction, preferably made of a plastic, molded one-piece construction, which provides a relatively rigid support of sufficient strength to support the user without flexing or otherwise changing shape.

Published U.S. Patent Application No. 2005/0277858 to Notestine describes a device for alleviating lower back pain consisting of a large ridged sheet member shaped to the align with contours of the human anatomy that extends from about the shoulder to the upper buttocks region of a patient and having a width corresponding to the width of the back of the patient. In practice the user, in a supine position, lies on top of the device.

U.S. Pat. No. 7,001,350 to Gross describes a portable device for providing variable lower back support consisting of an inflatable, portable lumbar cushion worn about the waist that exerts pressure against a chair back when the wearer is seated, which in turn creates pressure against the lumbar vertebrae and the paralumbar musculature. The inflatable cushion is connected to a pump operated manually by the wearer to control the flow of air into and out of the inflatable cushion.

U.S. Pat. No. 5,774,916 to Kurhi describes a rigid inflexible ergonomic support member assembly contoured to a corrected spinal curvature of an individual. The device relies on body weight to realign the spine of an individual using force developed by the user's body weigh.

U.S. Pat. No. 6,117,095 to Daggett et al. describes an adjustable, pneumatic, lumbar support apparatus consisting of a lower back pad positioned under the upper torso of a patient lying in a supine position; a temperature control apparatus; a leg-raising cushion; an inflatable bladder positioned under the lumbar region of the back and an electric air compressor.

U.S. Pat. No. 5,479,667 to Nelson et al. describes an ergonomic pillow assembly consisting of a head support assembly to receive and support a user's skull section and neck portion connected to a thoracic support assembly which in turn is connected to a waist and lumbar support assembly.

Such devices of the known art are often large, heavy, burdensome to use, uncomfortable to use, unduly restrictive of movement or they do not provide the proper back support and massaging pressure to be useful. Therefore, none of the above inventions and patents, taken either singularly or in combination, is seen to describe the present invention as claimed.

Therefore, a need exists for an ergonomic support and self-massaging device for alleviating back pain that is portable and easy to use. A need also exists for a device for alleviating back pain that is inexpensive and easily fabricated. A further need exists for a device for alleviating back pain that is accessible to a user in a variety of venues. The present invention addresses these and other needs.

### SUMMARY OF THE INVENTION

A massaging device for alleviating back pain comprising an array of at least three individual spherical elements, a flat base and a pliable covering that encases the spherical elements and at least a portion of the flat base. The plurality of spherical elements are disposed upon the flat base such they are coplanar and are in intimate contact with the surface of the flat base so as to permit the spherical elements free rotational and translational movement while maintaining coplanarity. The spherical elements can rigid or flexible and can be solid or hollow. The spherical elements can be constructed of a resilient material such as an elastomer In certain embodiments the spherical elements are essentially hollow shells filled with a plurality of micro-beads. In certain other embodiments the spherical elements comprise a cellular material. In preferred embodiments the spherical elements are of sufficient strength to support the weight of an average human body lying in a supine position.

In preferred embodiments the pliable covering comprises a natural or synthetic leather, a textile or a flexible plastic film. In certain other embodiments the pliable covering comprises an elastomeric textile made from yarns such as such as Spandex or elastane.

In certain preferred embodiments the pliable covering completely encases the rigid base and the plurality of spherical elements.

A self-applied method for alleviating back pain user of a comprises the steps of: disposing one's body in a supine position on a flat surface; disposing a device of the present invention under a painful area of the back such that the bottom surface of the flat rigid base is in contact with the flat surface and wherein the device maintains intimate contact with the painful area of the back; and making small movements in all directions to apply a massaging pressure to the painful area of the back while maintaining the intimate contact between the back and the device.

Another self-applied method for alleviating back pain comprising the steps of: disposing one's body upright in a chair having a chair back; disposing device of the present invention between a painful area of the back such that the bottom surface of the base element is in contact with the chair-back and wherein the device maintains intimate contact with the painful area of the back; and making small movements in all directions to apply a massaging pressure to the painful area of the back while maintaining the intimate contact between the back and the device.

### BRIEF DESCRIPTION OF THE DRAWINGS

FIG. 1a depicts a top-view of three spherical elements disposed upon an essentially triangular base.

FIG. 1b depicts a top-view of four spherical elements disposed upon an essentially square base.

FIG. 1c depicts a top-view of six spherical elements disposed upon an essentially rectangular base.

FIG. 1d depicts a top-view of seven spherical elements disposed upon an essentially circular base.

FIG. 2 depicts an isometric view of an assembled massage device containing six spherical elements.

FIG. 3 depicts an isometric view of the massaging device of FIG. 2 with cut-out section.

FIG. 4 depicts an exploded view of the device of FIG. 2.

FIG. 5 depicts a massaging device positioned against the back of a user in a supine position.

FIG. 6 depicts a massaging device positioned against the back of a user in a seated position.

### DETAILED DESCRIPTION OF THE INVENTION

The present invention presents a self-applied massaging device for alleviating back pain comprising an array of three or more individual spherical elements, a flat base having a top surface and a bottom surface wherein the flat base is suitably sized to accommodate the array of spherical elements and a pliable covering that encases the spherical elements and at least a portion of the flat base. The spherical elements are disposed such they are coplanar and are in intimate contact with the top surface of the flat base while they are allowed free rotational movement and translational movement while maintaining coplanarity.

In certain embodiments the pliable covering completely encases both the spherical elements and the entire flat base. In certain other embodiments the pliable covering encases the spherical elements and is fixedly attached to the flat base along all edges of the flat base. In yet other embodiments the pliable covering encases the spherical elements and a portion of the flat base that extends to the perimeter of the bottom surface where it is fixedly attached. In certain preferred embodiments of the device the spherical elements, the flat base and the pliable covering components are constructed such that neither the spherical elements nor the flat base are removable from the pliable covering without breaching the fixed attachment. In such embodiments the pliable covering can be fixedly attached to the flat base by any known fixation means such as sewing, gluing, stapling, Velcro™ attachment, zipper attachment and the like. In certain other preferred embodiments the pliable covering is essentially a bag-like structure that completely encases and contains the spherical elements as well as the entire flat. In such embodiments the bag can sealed by sewing or can be closed with a sealing means such as a zipper or Velcro™ closure.

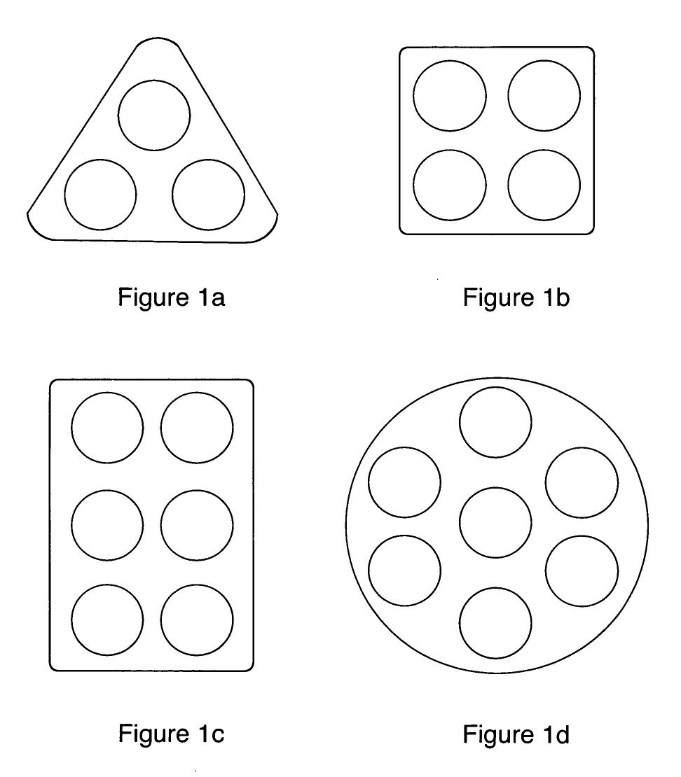

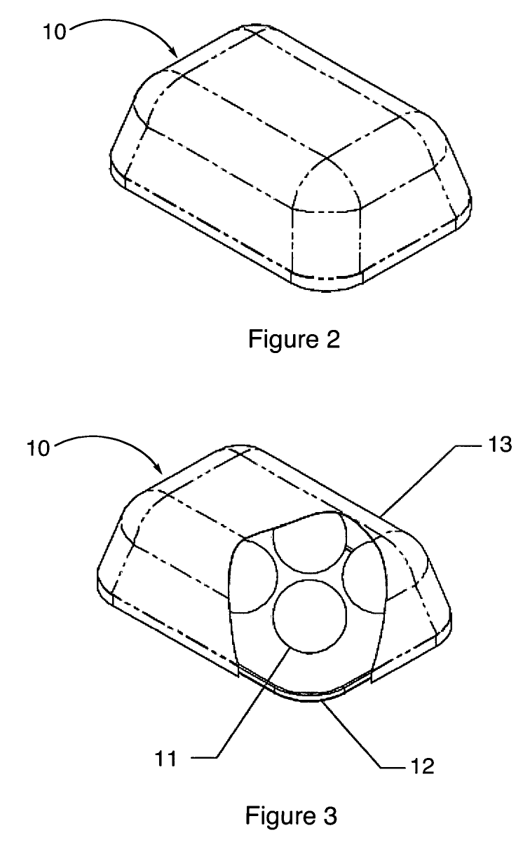

In embodiments of the instant invention the flat base can be of any convenient regular or non-regular shape. For example, in certain embodiments wherein the number of spherical elements is three or a multiple of three the flat base can be essentially triangular. In FIG. 1a is depicted a top view of three spherical elements disposed upon a triangular base schematic. In certain embodiments wherein the number of spherical elements is four the flat base can be essentially square as depicted in FIG. 1b. In other embodiments wherein the number of spherical elements is an even number greater than four the flat base can be essentially rectangular as depicted in FIG. 2c. In other embodiments wherein the number of spherical elements and their arrangement allow the flat base can be essentially circular as depicted in FIG. 1d. In yet other embodiments the flat base can assume any of a number of irregular shapes are may be suitable for the number and size of the spherical elements. While there is no limitation to the number of spherical elements used in embodiments of the invention, however in preferred embodiments the number of spherical elements ranges from three to fifteen with four to eight being most preferred. The size of the spherical elements and the spacing between spherical elements is generally non-limiting provided that, when in use, the spherical elements maintain contact with the flat base and are free to move relative to one another and that the spherical elements are sufficiently close to one another to prevent the body of the user from contacting the flat base. In certain preferred embodiments the spacing between the spherical elements is less than or equal to about one-half of the diameter of an individual spherical element.

In preferred embodiments of the present invention the device is sized to fit conveniently within the area of the back of the user and the device may be sized differently to accommodate users of differing body sizes. In general the devices of the present invention are applicable to all areas of the back particularly in the areas of the lumbar, thoracic and cervical portions of the spine. Therefore, the dimensions of embodiments of the invention depicted herein should not be construed as limiting. Certain preferred embodiments comprise a rectangular flat base dimensioned to be within the range of 8 to 12 inches by 3 to 6 inches with spherical elements each having a diameter within the range of 1.0 to 2.5 inches.

For use in embodiments of the present invention the spherical elements may be rigid or flexible. In preferred embodiments spherical elements are constructed of materials of sufficient strength to allow the plurality of spherical elements to support the weight of an average human body lying in a supine position.

In embodiments wherein the spherical elements are flexible the spherical elements are fabricated from materials that are sufficiently resilient. For purposes of the present invention the term “resilient” is defined as the capacity of a material to recover from a deformation. This property is also known as elastic recovery and materials with this property are known as elastomers, e.g. various types of rubber are elastomers. For use in certain preferred embodiments of the present invention the spherical elements are fabricated from resilient materials and have sufficient strength to withstand the pressure exerted by the weight of an average human body without collapsing to a diameter less than the 50% of the original diameter. Although such resilient spherical elements may slightly deform under the stress of weight of an average human body, the elements recover from such deformation to resume their original diameter when the stress is removed.

In certain embodiments of the invention the spherical elements are fabricated from a cellular elastomer such as a sponge rubber chosen for the required combination of non-collapsibility and resiliency. In certain embodiments of the present invention the resilient spherical elements are essentially hollow and certain preferred embodiments utilize hollow rubber balls similar to tennis balls. Such hollow resilient spherical elements are fabricated from materials chosen for the required combination of non-collapsibility and resiliency and may be filled with air or an inert gases such as nitrogen. In certain other embodiments of the present invention the hollow resilient spherical elements contain a plurality of micro-beads, wherein such micro-beads are fabricated from a number of materials including, but not limited to, rubbers, plastics and gels. Such micro-beads are readily available and usually range in size from 0.05 mm to 0.75 mm in diameter. In preferred embodiments the spherical elements are of essentially equal size.

The rigid flat base of devices of the present invention may be fabricated from any suitable rigid material including, but not limited to wood, plastic, laminates, composites and the like. The material must be sufficiently rigid to not significantly deform or warp under the pressure exerted by the weight of the body of the user and must be sufficiently strong to not break under the pressure exerted by weight of the body of the user. While the thickness of the flat base is not limiting, a base thickness of 0.1 to 1.0 inch is preferred and a base thickness of 0.2 to 0.5 inch is most preferred. Additionally the rigid flat base may be of solid or cellular construction.

Suitable materials for the pliable covering of devices of the present invention include natural and synthetic leathers, textiles such as knitted or woven fabrics, non-woven textiles, plastic films and the like. In preferred embodiments the materials chosen for the pliable coverings have high resistance to tearing and/or abrasion. In embodiments wherein the pliable covering encases both the spherical elements and the entire flat base the pliable covering is essentially a suitably sized sealed bag. In certain other embodiments wherein the pliable covering encases the spherical elements and is fixedly attached to the flat base along all edges of the flat base the fixation can be achieved by any known method such as gluing, sewing, tacking, stapling and the like or any combination thereof. In yet other embodiments wherein the pliable covering encases the spherical elements and a portion of the flat base that extends to the perimeter of the bottom surface of the flat base where it is fixedly attached to the base, the fixation can be achieved by any known method such as gluing, sewing, tacking, stapling and the like or any combination thereof.

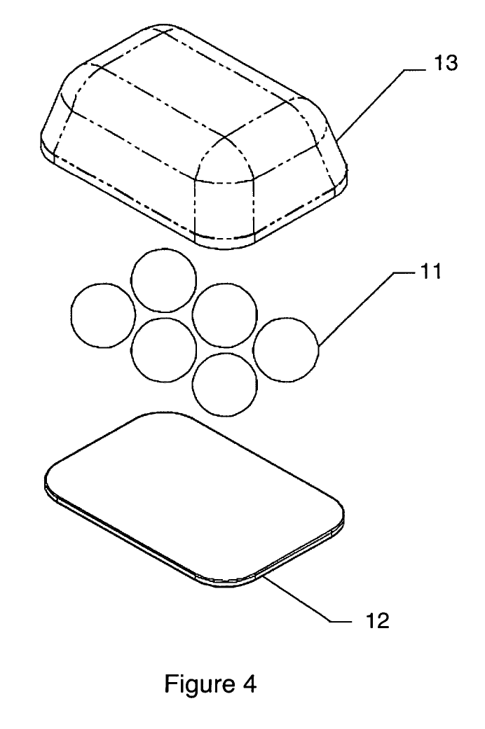

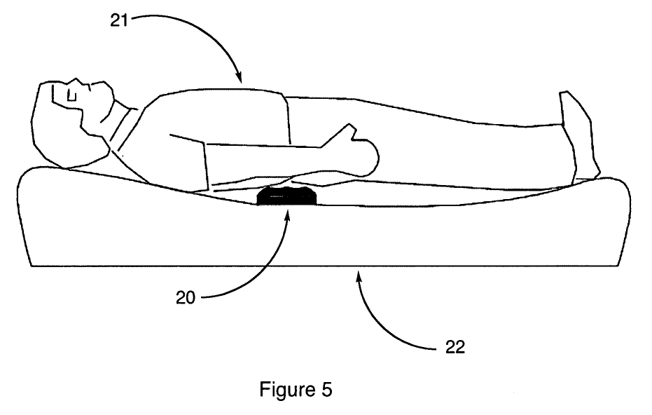

In FIG. 2 is depicted an isometric view of an assembled massaging device 10 of the present invention comprising a rectangular base. The same device 10 is depicted in FIG. 3 wherein, for illustrative purposes, a cut-out portion in the pliable covering 13 exposes the spherical elements 11 disposed upon the flat base 12. The same device that is depicted in FIGS. 2 and 3 is depicted in FIG. 4 in an exploded isometric view that clearly illustrates the relationship between the spherical elements 11, the flat base 12 and the pliable covering 13.

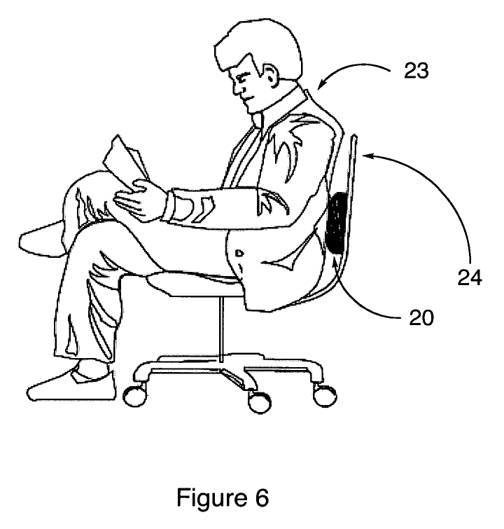

A self-applied method of use of a device of the present invention is shown in FIG. 5 wherein a massaging device 20 is disposed under a painful area of the back of the body 21 of a user wherein the user is lying in a supine position upon a flat surface 22 and wherein the device maintains intimate contact with the painful area of the back while the bottom surface of the base element is in contact with the flat surface. The use then makes small movements in all directions to apply a massaging pressure to the painful area of the back while maintaining the intimate contact between the back and the device.

Another self-applied method of use of a device of the present invention is shown in FIG. 6 wherein a user is seated in an upright chair comprising a chair-back 24 and wherein a massaging device 20 is disposed between a painful area of the back of the body of user 23 and the chair-back 24. The user then makes making small movements in all directions to apply a massaging pressure to the painful area of the back while maintaining the intimate contact between the back and the device.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof.

We claim:

1. A massaging device comprising:
a rigid flat base comprising a top surface and a bottom surface;
a plurality of coplanar spherical elements in intimate contact with the top surface of the flat base and spaced to permit rotational movement and translational movement while maintaining coplanarity; and
a pliable covering that encases the spherical elements and at least a portion of the flat base.

2. The device of claim 1 wherein said spherical elements are solid.

3. The device of claim 1 wherein said spherical elements comprise a cellular material.

4. The device of claim 1 wherein said spherical elements are hollow.

5. The device of claim 1 wherein said spherical elements comprise a shell filled with a plurality of micro-beads.

6. The device of claim 1 wherein said spherical elements comprise a rigid material.

7. The device of claim 1 wherein said spherical elements comprise a resilient material.

8. The device of claim 7 wherein said resilient material is an elastomer.

9. The device of claim 1 wherein the spherical elements are of sufficient strength to support the weight of an average human body lying in a supine position.

10. The device of claim 1 wherein said pliable covering comprises a natural or synthetic leather.

11. The device of claim 1 wherein said pliable covering comprises a textile.

12. The device of claim 9 wherein said textile is an elastomeric textile.

13. The device of claim 1 wherein said pliable covering comprises a flexible plastic film.

14. The device of claim 1 wherein said pliable covering completely encases said rigid base and said plurality of spherical elements.

15. The device of claim 1 wherein the number of spherical elements is three to eight.

16. The device of claim 1 wherein the number of spherical elements is four to six.

17. A self-applied method for alleviating back pain comprising the steps of:
i. disposing one's body in a supine position on a flat surface;
ii. disposing the device of claim 1 under a painful area of the back such that the bottom surface of the flat rigid base is in contact with the flat surface and wherein the device maintains intimate contact with the painful area of the back; and
ii. making small movements in all directions to apply a massaging pressure to the painful area of the back while maintaining the intimate contact between the back and the device.

18. A self-applied method for alleviating back pain comprising the steps of:
i. disposing one's body upright in a chair having a chair back;
ii. disposing the device of claim 1 between a painful area of the back such that the bottom surface of the base element is in contact with the chair back and wherein the device maintains intimate contact with the painful area of the back; and
iii. making small movements in all directions to apply a massaging pressure to the painful area of the back while maintaining the intimate contact between the back and the device.
